(19) United States
(12) Patent Application Publication
(10) Pub. No.: US 2026/0059478 A1
(43) Pub. Date: Feb. 26, 2026

(54) HYBRID POSITIONING WITH A PLURALITY OF RADIO FREQUENCY (RF) TECHNOLOGIES

(71) Applicant: QUALCOMM Incorporated, San Diego, CA (US)

(72) Inventors: Varun Amar REDDY, San Diego, CA (US); Alexandros MANOLAKOS, Athens, Attikí (GR); Krishna Kiran MUKKAVILLI, San Diego, CA (US)

(21) Appl. No.: 19/104,693

(22) PCT Filed: Sep. 8, 2023
(86) PCT No.: PCT/US2023/073724

§ 371 Date: Feb. 18, 2025

(30) Foreign Application Priority Data
Oct. 31, 2022 (GR) 20220100878

(51) Int. Cl. H04W 64/00; H04B 1/7163; H04W 8/22; H04W 24/10

(52) U.S. Cl. CPC H04W 64/00; H04B 1/7163; H04W 8/22; H04W 24/10

(57) ABSTRACT

An example method of hybrid positioning performed by a coordinating radio frequency (RF) device. The method may comprise requesting one or more capability reports from one or more participating RF devices, wherein a capability report comprises parameters indicating whether the participating RF device: participates in a present hybrid positioning session utilizing each of a plurality of RF positioning technologies; and supports one or more RF channels for RF positioning; receiving, from each participating RF device, the corresponding capability report. The method may also comprise transmitting, to the participating RF devices that participate in the present hybrid positioning session, a hybrid positioning session configuration, determined based on the capability reports.

### RELATED APPLICATIONS

This application claims the benefit of Greek Application No. 20220100878, filed Oct. 31, 2022, entitled “HYBRID POSITIONING WITH A PLURALITY OF RADIO FREQUENCY (RF) TECHNOLOGIES”, which is assigned to the assignee hereof, and incorporated herein in its entirety by reference.

### BACKGROUND

### 1. Field of Disclosure

The present disclosure relates generally to the field of radiofrequency (RF)-based position determination (or positioning) of an electronic wireless device. More specifically the present disclosure relates to hybrid positioning.

### 2. Description of Related Art

The positioning of devices can have a wide range of consumer, industrial, commercial, military, and other applications. The position of a device can be estimated based on information gathered using different RF positioning technologies. For example, UWB-based positioning offers a highly-accurate, low-power positioning solution relative to other RF-based positioning techniques for wireless electronic devices. In many indoor scenarios, Wi-Fi-based positioning can also provide accurate position estimation to a target device using one or more Wi-Fi access points (APs). Moreover, a cellular network (e.g., implemented according to 5G New Radio (NR)) can also provide position solution(s) to the target device.

### BRIEF SUMMARY

An example method of hybrid positioning performed by a coordinating radio frequency (RF) device. The method may comprise requesting one or more capability reports from one or more participating RF devices, wherein a capability report comprises parameters indicating whether the participating RF device: participates in a present hybrid positioning session utilizing each of a plurality of RF positioning technologies; and supports one or more RF channels for RF positioning; receiving, from each participating RF device, the corresponding capability report. The method may also comprise transmitting, to the participating RF devices that participate in the present hybrid positioning session, a hybrid positioning session configuration, determined based on the capability reports.

An example method of hybrid positioning performed by a participating radio frequency (RF) device. The method may comprise receiving, from a coordinating RF device, a request for a capability report, indicating whether the participating RF device participates in a present hybrid positioning session utilizing each of a plurality of RF positioning technologies; and supports one or more RF channels for RF positioning; receiving, from each participating RF device, the corresponding capability report. The method may also comprise transmitting, to the coordinating RF device, the capability report. In response to participating the present hybrid positioning session, the method may also comprise receiving, from the coordinating RF device, a hybrid positioning session configuration, determined based on the capability report.

An example coordinating radio frequency (RF) device for hybrid positioning, the coordination RF device comprising a transceiver, a memory, one or more processors communicatively coupled with the transceiver and the memory, wherein the one or more processors may be configured to request one or more capability reports from one or more participating RF devices, wherein a capability report comprises parameters indicating whether the participating RF device: participates in a present hybrid positioning session utilize each of a plurality of RF positioning technologies; and supports one or more RF channels for RF positioning. The one or more processors may also be configured to receive, from each participating RF device, the corresponding capability report. The one or more processors may also be configured to transmit, to the participating RF devices that participate in the present hybrid positioning session, a hybrid positioning session configuration, determined based on the capability reports.

An example participating radio frequency (RF) device for hybrid positioning, the coordination RF device comprising a transceiver, a memory, one or more processors communicatively coupled with the transceiver and the memory, wherein the one or more processors may be configured to receive, from a coordinating RF device, a request for a capability report, indicating whether the participating RF device: participates in a present hybrid positioning session utilize each of a plurality of RF positioning technologies; and supports one or more RF channels for RF positioning. In response to participating the present hybrid positioning session, the one or more processors may also be configured to receive, from the coordinating RF device, a hybrid positioning session configuration, determined based on the capability report.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2A is a diagram illustrating a scenario in which both to ultra-wideband (UWB) and cellular (5G new radio (NR)) wireless technologies may be used for positioning a target device.

FIG. 2B is a simplified diagram illustrating how positioning of a target device may be performed, according to some embodiments.

FIGS. 3A and 3B are flow diagrams illustrating the roles different devices may assume with regard to a UWB ranging session.

FIG. 4 is a timing diagram showing an example of a frame structure for a UWB ranging session and associated terminology.

FIG. 5 is a timing diagram showing an example of a measurement exchange sequence with regard to a non-trigger based (NTB) Wi-Fi ranging session and associated terminology.

FIG. 6 is a timing diagram illustrating a measurement sounding phase of an NTB Wi-Fi ranging session.

FIG. 7 is a flow diagram illustrating how a coordinating device may be used to coordinate hybrid positioning session of one or more participating RF devices, according to some embodiments.

FIGS. 8A and 8B are flow diagrams illustrating hybrid UWB/Wi-Fi positioning sessions, according to some embodiments.

FIG. 9 is a flow diagram illustrating how one or more access points (APs) may be positioned, according to some embodiments.

FIG. 10 is a flow diagram of a method of hybrid positioning performed by a coordinating radio frequency (RF) device, according to an embodiment.

FIG. 11 is a flow diagram of a method of hybrid positioning performed by a participating RF device, according to an embodiment.

FIG. 12 is a block diagram of an embodiment of a UE, which can be utilized in embodiments as described herein.

FIG. 13 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE). As described in more detail herein, such signals may comprise any of a variety of signal types but may not necessarily be limited to a Positioning Reference Signal (PRS) as defined in relevant wireless standards.

Further, unless otherwise specified, the term “positioning” as used herein (including, for example, UWB-based positioning, Wi-FI-based positioning, cellular-based positioning, and hybrid positioning) may absolute location determination, relative location determination, ranging, or a combination thereof. Such positioning may include and/or be based on timing, angular, phase, or power measurements, or a combination thereof (which may include RF sensing measurements) for the purpose of location or sensing services.

As previously noted, UWB-based positioning offers a highly-accurate, low-power positioning solution relative to other RF-based positioning techniques for wireless electronic devices. UWB-based positioning can be used in industrial applications, such as by robots and/or other Internet of Things (IoT) devices in a factory setting, indoor positioning of consumer electronics, and more. Although UWB-based positioning may be used in an ad hoc manner as a standalone positioning technique between electronic devices capable of UWB positioning (also referred to herein as “UWB devices”), due to extreme proximity of multiple radio transceivers (e.g., radio transceivers for different RF technologies such as UWB, Wi-Fi, and/or 5G new radio (NR)) within a same RF device (e.g., a UE) operating on adjacent frequencies or sub-harmonic frequencies, the interference power coming from a transmitter of the collocated radio (e.g., Wi-Fi signals and/or NR signals) may be much higher than the received power level of the desired signal (e.g., the UWB signal) for a receiver. This could negatively affect the positioning accuracy and/or efficiency of the RF device.

When an RF device operates on multiple RF technologies, existing in-device coexistence approaches focus primarily on facilitating data transmissions across the different RF technologies (e.g., coordinating data transmission links of different RF technologies based on time-divisional-multiplex (TDM) and/or frequency-divisional-multiplex (FDM)). When it comes to positioning (e.g., positioning a target device capable of operating on the multiple RF technologies), as will be disclosed herein, a positioning method that could utilize the multiple RF technologies (e.g., coordinating different RF positioning technologies) may not only reduce the interference caused by sharing RF bandwidth and/or transceivers, but may also increase the accuracy of the positioning. Embodiments herein can address these and other issues by enabling the coexistence of multiple RF technologies for positioning.

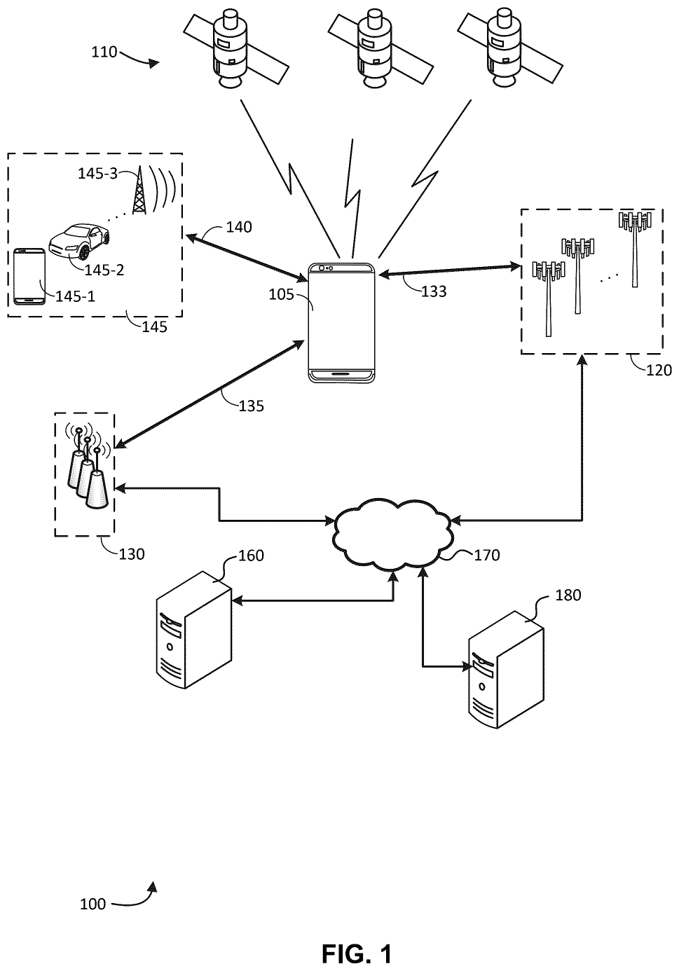

FIG. 1 is a simplified illustration of a positioning system 100 in which a UE 105, location server 160, and/or other components of the positioning system 100 can use the techniques provided herein for hybrid positioning, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include an LTE wireless network, a Fifth Generation (5G) wireless network (also referred to as an NR wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the mobile device 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g., with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a GNSS such as GPS, GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), UWB, IEEE 802.15x, or a combination thereof. Mobile devices 145 may additionally or alternatively use non-RF wireless signals for positioning of the mobile device 105, such as infrared signals or other optical technologies.

Mobile devices 145 may comprise other mobile devices communicatively coupled with a cellular or other mobile network (e.g., network 170). When one or more other mobile devices 145 are used in the position determination of a particular mobile device 105, the mobile device 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another mobile device) at some known previous time). A location may be specified as a geodetic location comprising coordinates which may be absolute (e.g., latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

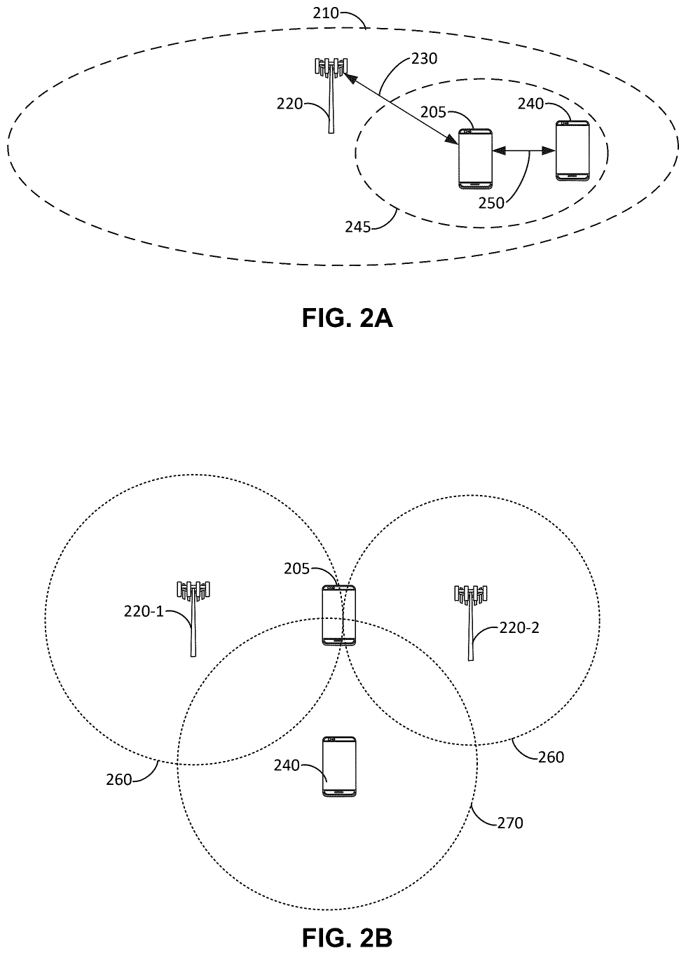

FIG. 2A is a diagram illustrating a scenario in which both UWB and cellular (5G NR) technologies may be used for positioning a target device 205. Here, target device 205 may correspond with mobile device 105 of FIG. 1. Generally put, according to some embodiments, the hybrid cellular/UWB positioning (or simply “cellular/UWB positioning”) of a device may utilize both cellular and UWB positioning technologies to determine the location of a device that is capable of taking positioning-related measurements in both cellular and UWB technologies. The use of both cellular and UWB technologies may utilize additional anchors (cellular and/or UWB anchors) for positioning measurements, which can allow for positioning of a device in situations where the use of a single technology would not, and/or increased accuracy over the use of a single technology. Hybrid cellular/UWB positioning also may be referred to as (hybrid) “5G/UWB” or “NR/UWB” positioning where cellular technology comprises 5G NR.

In this scenario, a target device 205 may comprise a UE of the cellular network within a coverage region 245 of a base station 220, which may comprise a serving base station of the target device 205. Communication between the base station 220 and target device 205 may occur across a network (Uu) interface 230, which may also be used to communicate DL and/or UL reference signals for cellular aspects of hybrid cellular/UWB positioning. According to some embodiments, the positioning of the target device 205 may be coordinated by the network via a location server (not shown), and related configuration data and/or assistance data may be related to the target device 205 by the base station 220 via the network interface 230.

The UWB aspects of hybrid cellular/UWB positioning, the target device 205 may send and/or receive UWB RF signals from UWB device 240, acting as a UWB anchor. The UWB RF signals may be coordinated using an out of band (OOB) interface 250, which may utilize Bluetooth, Wi-Fi, or similar wireless technology, for example, which may have a corresponding wireless coverage region 245. According to some embodiments, the UWB aspects of hybrid cellular/UWB positioning may be coordinated by the target device 205 and/or UWB device 240, or maybe coordinated by location or other server (not shown). In some embodiments, configuration data and/or assistance data may be provided to a target device 205 and/or UWB device 240 directly by the base station 220. In some embodiments, configuration data and/or assistance data may be provided to a target device 205 directly by the base station 220 (e.g., via the network interface 230), and the target device 205 may relay the configuration data and/or assistance data to the UWB device 240 (e.g., via the GOB interface 250.

It can be noted that, although a single base station 220 and a single UWB device 240 are illustrated in FIG. 2, scenarios in which hybrid cellular/UWB positioning of a target device 205 may include one or more base stations and one or more UWB devices.

FIG. 2B is a simplified diagram illustrating how positioning of the target device 205 may be performed, according to some embodiments. Here, measurements using cellular technology may comprise round trip signal propagation delay (RTT) measurements performed between the target device 205 and each of a first base station 220-1 and a second the base station 220-2 to determine a distance between the target device 205 and the base stations 220. (These distances are represented by circles 260.) Additionally, as indicated, measurements and UWB may comprise RTT measurements (also referred to as two-way ranging (TWR) in UWB) performed to determine a distance between the target device 205 and one or more UWB anchors, such as UWB device 240. (The distance between the target device 205 and the UWB device 240 is represented by circles 270.) Using multilateration, the location of the target device 205 may be determined as location in which circles representing the distances (circles 260 and 270) intersect. Because the distances may have some uncertainty, the resulting location of the location of the target device 205 also may have some uncertainty.

As noted above, a single RF device may be capable of communicating using may different RF technologies (e.g., having radio transceivers for different RF technologies such as UWB, Wi-Fi, and/or NR). In many indoor scenarios, both UWB-based and Wi-Fi-based positioning/ranging may provide accurate position estimation to a target (e.g., target device 205 FIG. 2A or UWB device 240 of FIG. 2B, or mobile device 105 of FIG. 1). Accordingly, positioning methods that could leverage the multiple RF technologies (e.g., coordinating different RF positioning technologies) may be advantageous.

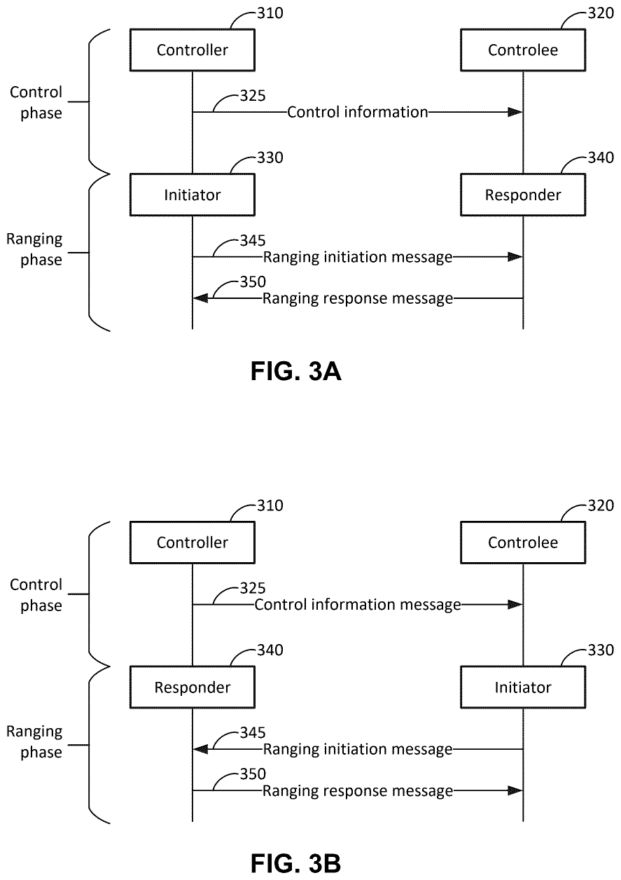

FIG. 3A is a flow diagram illustrating the roles different devices may assume with regard to a UWB ranging session (or simply a “UWB session”). Here, each UWB device may be referred to as an enhanced ranging device (ERDEV). ERDEVs may be referred to different terminologies (e.g., initiator/responder or controller/controlee) at different layers of the network stack. The terms initiator and responder (described hereafter) would be used at lower layers (e.g., at UWB physical (PHY) and media access control (MAC) layers), while the terms controller and controlee (also described hereafter) may be used at higher layers (e.g., an application layer of the ERDEVs). Here, either ERDEV may correspond with a target device 205 or UWB device 240 of FIG. 2, or mobile device 105 of FIG. 1.

As indicated, for a pair of ERDEVs communicating with each other, the controller 310 is an ERDEV that sends control information 325 to a receiving ERDEV, designated as the controlee 320. The control information 325 may include parameters for the UWB ranging session, such as timing, channel, etc. Although not illustrated, the controlee 320 can send acknowledgment to the control information 325, may negotiate changes to the parameters, and/or the like.

The exchange between controller 310 and controlee 320, including the sending of the control information 325 and subsequent related exchanges between controller 310 and controlee 320 regarding control information, may be conducted out of band (OOB) using a different wireless communication technology (e.g., Bluetooth or Wi-Fi), prior to a ranging phase. Put differently, a UWB session may be associated with a control phase and a ranging phase, where the control phase (which may take place on an OOB link) comprises a preliminary exchange between controller 310 and controlee 320 of parameter values for the ranging phase, and the subsequent ranging phase comprises the portion of the UWB session in which devices exchange messages within the UWB band for ranging measurements. (It can be noted, however, that some control information may be exchanged within the UWB band (e.g., a “ranging control phase” occurring in the first slot of a UWB round. Accordingly, some aspects of the control phase may be considered to occur in band, subsequent to the preliminary OOB exchange between the controller 310 and controlee 320.)

The UWB session may occur afterward, in accordance with the parameters provided in the control information. In the ranging phase of the UWB session, one ERDEV may take the role of an initiator 330 and the other ERDEV may take the role of a responder 340. As indicated in FIG. 3A, the initiator 330 may initiate UWB ranging by sending a ranging initiation message 345 to the responder 340, to which the responder 340 may reply with a ranging response message 350, and timing measurements may be made of these messages (by the devices receiving the messages) to perform two-way ranging (TWR). Depending on the parameters of the control information 325, additional exchanges may be made in the ranging phase between the initiator 330 and responder 340 to allow for additional ranging measurements.

The roles of initiator 330 and responder 340 may be indicated in the control information 325. Further, as indicated in FIG. 3A, the controller 310 in the control phase may be the initiator 330 in the ranging phase of the UWB session. Alternatively, as indicated in FIG. 3B, the controller 310 in the control phase may be the responder 340 in the ranging phase. The determination of which device is initiator 330 and which is responder 340 may depend on the parameters set forth in the control information 325, in which case the controlee 320 correspondingly becomes either the responder 340 or the initiator 330. According to some embodiments, a controller/initiator may conduct ranging with multiple controlees/responders.

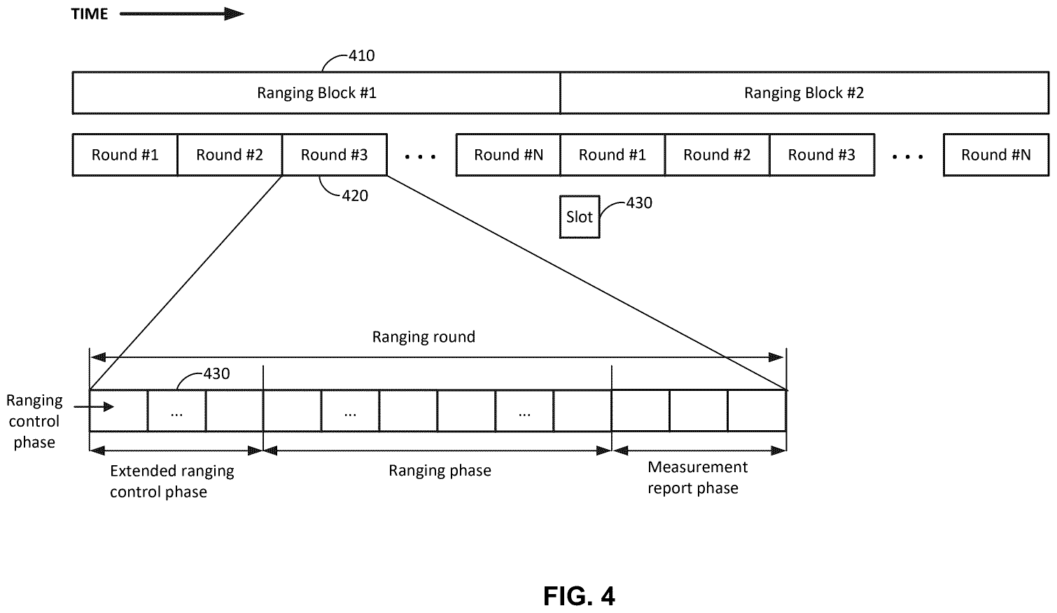

FIG. 4 is a timing diagram showing an example of a frame structure for a UWB ranging session and associated terminology. The timing in a UWB ranging session may occur over a period of time divided into sub-portions according to a hierarchical structure. Similar to a TDMA scheme, the UWB ranging session defines timing during which ranging can occur. This timing comprises one or more consecutive ranging blocks 410, which may have a configurable duration (e.g., 200 ms). Each ranging block 410 may be split into one or more successive rounds 420 (e.g., N rounds), the number and length of which are configurable. As noted above, each round may be assigned/arranged to a cluster (e.g., the cluster 210 in FIG. 2) for message transmission. The responder (e.g., responders 222-2, 222-3, and 222-4 in FIG. 2 and/or responders 340 in FIGS. 3A and 3B) may transmit messages only within the round assigned to the corresponding cluster. In some embodiments, the arrangement may be identified in the control information using its corresponding round index (e.g., Round #3). For example, the round index may be either statically configured by the controller (e.g., controller 310 in FIGS. 3A and 3B) or may be selected as per a hopping pattern.

Rounds 420 may further be split into different slots 430, which also have a configurable number and length. Slots 430 may be arranged sequentially to perform the positioning and/or ranging (e.g., Time-Difference-of-Arrival (TDoA) and/or or Angle-of-Arrival (ToA)). For example, slots 430 in rounds 420 may be scheduled into a ranging control phase (e.g., a signal slot) or an extended ranging control phrase, a ranging phase, and a measurement report phase, where the length/number of slots 430 in each phase is configurable. For example, the extended ranging control phase may include one or more slots 430 corresponding to the controllers of the cluster which round 420 is assigned to (e.g., M slots in the extended control phase may correspond to M controllers of the cluster). In some embodiments, in UWB ranging scenarios, the ranging control phase may only include a signal slot.

As noted above, when performing UWB sessions (e.g., performing UWB ranging sessions), potential RF interferences on the communicating channel (e.g., RF interferences caused by the other UBW devices in the vicinity (e.g., other UWB ranging/data transmission pare) and/or other Radio Access Technologies (RATs)) may cause information exchange inefficiency and/or inaccuracy of the measurements. Existing solutions such as applying slot-level CAA and fragmentation (e.g., fragmenting the preamble/synchronization packet and transmitting the fragments across several milliseconds) on the entire ranging block may lead to larger latency of the data transmission, and adding more logic and complexity to the MAC. The technical solutions described herein provides improved interference mitigation techniques for UWB sessions that could reduce/avoid the RF interference without introducing much complexity to the MAC nor increasing much ranging latency.

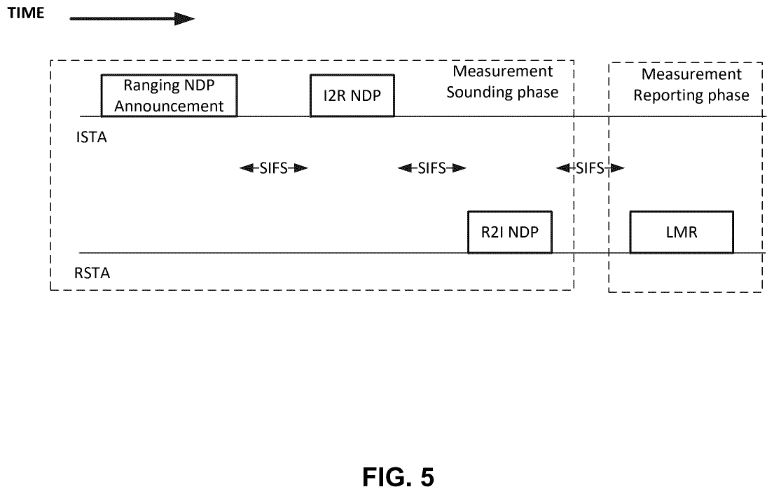

FIG. 5 is a timing diagram showing an example of a measurement exchange sequence with regard to a NTB Wi-Fi ranging session (or simply a “Wi-Fi session”) and associated terminology. Here, an initiating station (ISTA) may correspond with target device 205 or UWB device 240 of FIG. 2, or mobile device 105 of FIG. 1. A responding station (RSTA) may correspond with APs 130 of FIG. 1. In an NTB ranging session, the RSTA may respond to a single ISTA.

A Wi-Fi ranging session may include a measurement sounding phase and a measurement reporting phase. The measurement sounding phase may start with the ISTA transmitting a ranging null data packet (NDP) announcement to the RSTA using carrier sense multiple access/collision avoidance (CSMA/CA). After the NDP announcement being successfully transmitted, the ISTA may retain the RF channel for a predetermined duration. As indicated in FIG. 5, during the measurement sounding phase, the ISTA and the RSTA may transmit NDPs (e.g., an I2R NDP and a R2N NDP) at different time stamps and may perform the positioning based on the time stamps. Each of the transmission (e.g., the NDP announcement, the I2R NDP, the R2N NDP, and a location measurement report (LMR) transmitted in the measurement reporting phase) may be separated by the shortest interframe spacing (SIFS) (e.g., an interval of about 16 s) as defined in the Wi-Fi specification.

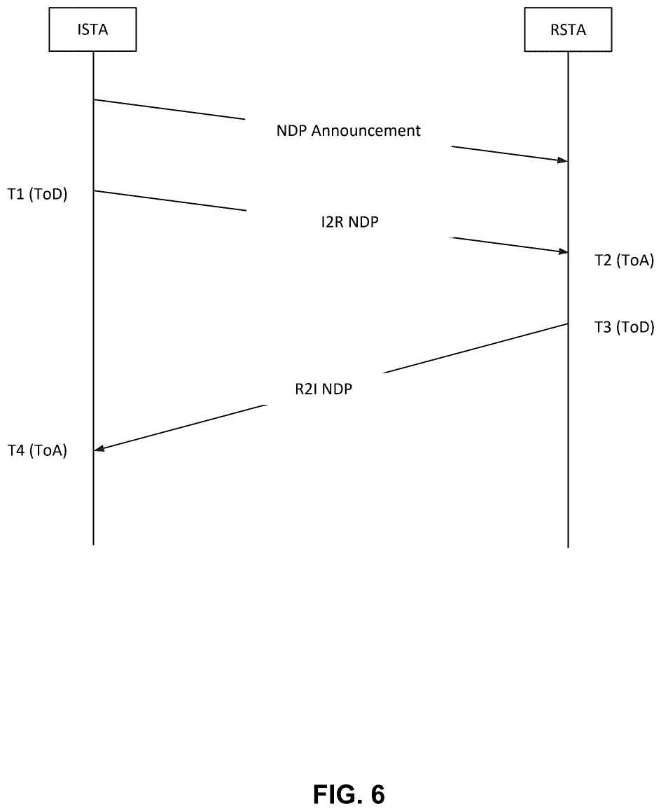

FIG. 6 is a timing diagram illustrating a measurement sounding phase of a NTB Wi-Fi ranging session, which may correspond to the measurement sounding phase previously described with respect to FIG. 5. As noted above, the NTB Wi-Fi ranging session may be based on RTT measurements of the NDPs transmitted at different time stamps. In one example, as illustrated in FIG. 6, after successfully transmit the NDP announcement, at time stamp t1, the ISTA may transmit the I2R NDP (e.g., an uplink NDP) to the RSTA and may record the time stamp as time of departure (ToD)1. At time stamp t2, the RSTA may receive the I2R NDP and may record the time stamp as time of arrival (ToA)1. At time stamp t3, the RSTA may transmit a R2I NDP (e.g., a downlink NDP) to the ISTA and may record the time stamp as ToD2. At time stamp t4, the ISTA may receive the R2I NDP and may record the time stamp as ToA2. After the ISTA receives the LMR (e.g., shown in FIG. 5, transmitted at the measurement reporting phase), RTT may be derived as:

$$RTT = t 4 - t 1 - ( t 3 - t 2 )$$

Accordingly, the range R between the ISTA and the RSTA may be determined as:

$$R = RTT * c / 2$$

Where c is the speed of light.

As noted above, in many indoor scenarios, both UWB-based and Wi-Fi-based positioning/ranging may provide accurate position estimation to a target device (e.g., target device 205 of FIG. 2A or UWB device 240 of FIG. 2B, or mobile device 105 of FIG. 1). Accordingly, positioning methods that could leverage both UWB-based and Wi-Fi-based positioning/ranging (e.g., coordinating the UWB ranging session and the Wi-Fi-based positioning session) may be advantageous.

For example, FIG. 5 is a flow diagram illustrating how a coordinating device may be used to coordinate hybrid positioning session of one or more participating RF devices, according to some embodiments. In some embodiments, the hybrid positioning may be performed between a coordinating RF device 705 and one or more participating RF devices 710. In some embodiments, coordinating RF device 705 may be an RF device capable of coordinating UWB-based and Wi-Fi-based positioning/ranging. For example, coordinating RF device 705 may be a UWB device corresponding to controller 310 shown in FIGS. 3A and 3B. In some embodiments, coordinating RF device 705 may also be a target device that assumes control of the coordination and propagates/relays the schedule information (e.g., a hybrid positioning session configuration) to the other devices (e.g., one or more participating RF devices 710 and/or one or more APs for the Wi-Fi-based positioning).

Alternatively or additionally, in some embodiments, if the number of nodes (e.g., the number of participating RF devices 710 and/or the number of APs used for Wi-Fi-based positioning) is large and/or the location of one or more of nodes is outside a signal RF device's coverage, coordinating RF device 705 may also be a server (e.g., a location server 160 shown in FIG. 1 or a private server) that supports the hybrid positioning disclosed herein. Operating with centralized control at a server may increase the scalability for performing the hybrid positioning session by reducing the synchronization error. Also, as will be discussed in detail below, the server may also be used for positioning the APs which are in turn used for positioning participating RF devices 710 in Wi-Fi based positioning.

In some embodiments, one or more participating RF devices 710 may be RF devices capable of performing UWB-based and Wi-Fi-based positioning and may correspond to target device 205 shown in FIG. 2, controlee 320 shown in FIGS. 3A and 3B, and the ISTA shown in FIGS. 5 and 6.

It is understood that the UWB-based and the Wi-Fi-based positioning here are used as non-limiting examples and are for illustrative purpose only. Any other suitable type of RF ranging technologies (e.g., contention-based RF technology other than Wi-Fi) may be coordinated/scheduled alternatively or in addition to the Wi-Fi-based positioning, according to the TDM and/or the FDM scheme provided by the UWB controller, similar to the scheme disclosed herein.

Starting at arrow 720, coordinating RF device 705 may request one or more capability reports from one or more participating RF devices 710. In some embodiments, each capability report may at least include parameters indicating whether the participating RF device: 1. participates in a present hybrid positioning session utilizing each of a plurality of RF positioning technologies (e.g., Wi-Fi, UWB, NR); 2. supports each of the plurality of RF positioning technologies; 3. supports one or more RF channels for RF positioning, or any combination thereof. In some embodiments, the capability report may also include parameters such as the desired position accuracy, configurations for the duty cycle, etc. In some embodiments, the corresponding information for each participating RF device 710 may be represented/indicated by one or more predetermined bits of the exchanged messages. For example, at a predetermined slot, “0” may represent not participating the present hybrid positioning session and “1” may represent participating the present hybrid positioning session.

At arrow 725, one or more participating RF device 710 may transmit the capability report to coordinating RF device 705.

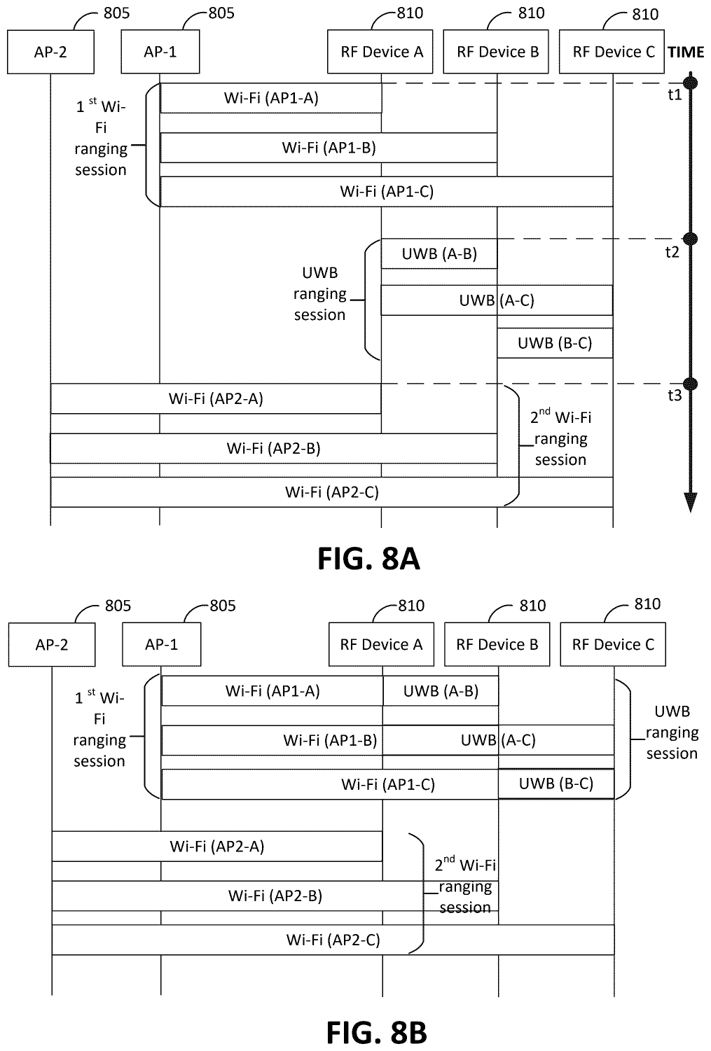

At block 730, coordinating RF device 705 may determine a hybrid positioning session configuration for the present hybrid positioning session based on the one or more capability reports. In some embodiments, the hybrid positioning session configuration may include information of 1. the time and frequency stamps, and an intended recipient for a transmission of one or more ranging messages of a given RF technology; 2. time and frequency stamps, and an intended transmitter for a reception of the one or more ranging messages of the given RF technology; and 3. periodicity parameters of the one or more ranging messages. In some embodiments, the periodicity parameters may include the number of the repetitions of the one or more ranging messages, duration of the hybrid positioning session (e.g., when a next capability report request may be exchanged), configuration for the duty cycle (e.g., define an “off” period where no reference signals are transmitted). Example hybrid positioning session configurations will be discuss in detail below with regard to the description of FIGS. 8A and 8B below.

At arrow 735, coordinating RF device 705 may transmit the hybrid positioning session configuration to one or more participating RF device 710 that participate in the present hybrid positioning session (e.g., indicated in the corresponding capability report). In some embodiments, the capability report may be included in the assistance data transmitted from coordinating RF device 705 to one or more participating RF device 710.

In some embodiments, part or all of the information exchange happened in the scheduling phase (e.g., the request for the capability report, the transmission of the capability report, and/or the transmission of the hybrid positioning session configuration) may be transmitted in band (e.g., using the UWB RF positioning channel), GOB (e.g., via other RF technologies such as internet, Bluetooth network, etc.), or any combination thereof. For example, the hybrid positioning session configuration may be included in a UWB control message (e.g., included in the (extended) ranging control phase shown in FIG. 4) transmitted from coordinating RF device 705 to one or more participating RF devices 710.

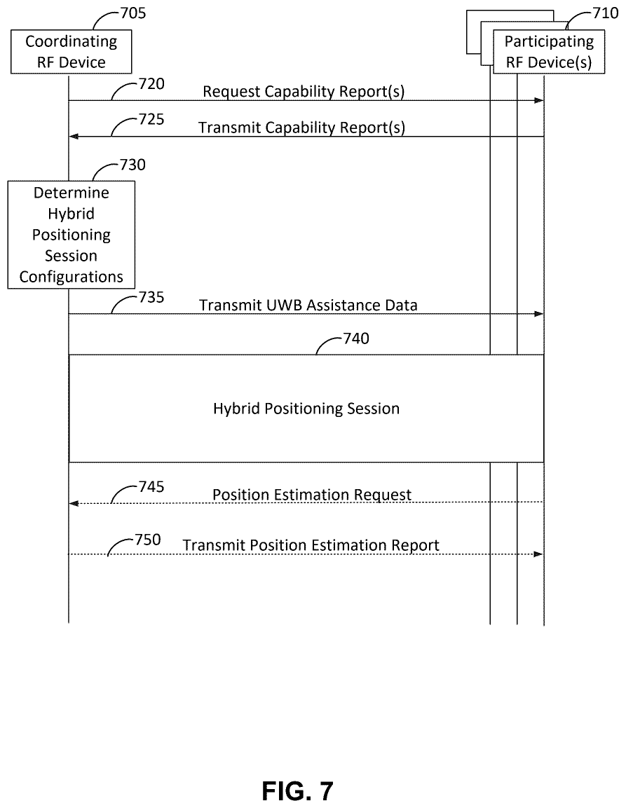

At arrow 740, the hybrid positioning session utilizing the plurality of RF positioning technologies may be performed between coordinating RF device 705 and one or more participating RF device 710 according to the hybrid positioning session configuration. For example, FIGS. 8A and 8B illustrate example hybrid UWB/Wi-Fi positioning sessions according to some embodiments. The hybrid positioning session may be scheduled between the participating RF devices, the coordination RF device (e.g., participating RF device 710 and coordination RF device 705 shown in FIG. 7), and one or more APs 805. In other words, RF devices 810 shown in FIGS. 8A and 8B may correspond to participating RF device 710 and/or coordination RF device 705 shown in FIG. 7. APs 805 may correspond to APs 130 in FIG. 1 and/or the RSTA in FIGS. 5 and 6. The detail of the Wi-Fi ranging session and the UWB ranging session discussed with regard to FIGS. 3-5 will not be repeated for ease of illustration.

In the example shown in FIG. 8A, the hybrid positioning session may be scheduled in a TDM fashion where a UWB ranging session may be performed between the two consecutive Wi-Fi ranging sessions. For example, the first Wi-Fi ranging session may be scheduled at time point t1 (e.g., start at the time point t1) between a first APs 805 (e.g., AP-1) and RF devices 810. A second Wi-Fi ranging session may be scheduled at a later time point t3 (t3>t1) between a second APs 805 (e.g., AP-2) and RF devices 810. The UWB session may be scheduled at a time point t2, between the time point t1 and the time point t3 (t3>t2>t1), among RF devices 810 (e.g., between initiators and responders shown in FIG. 3). In some embodiments the Wi-Fi packets used for the Wi-Fi ranging session may be set to use the smallest contention widow size before being transmitted.

In some embodiments, when non-interfering channels are available, the hybrid positioning session may also be scheduled in a FDM fashion. For example, as shown in FIG. 8B, the hybrid positioning session may be scheduled in a FDM manner where a UWB ranging session (e.g., performed between initiators and responders shown in FIG. 3) may be performed simultaneously with a Wi-Fi ranging session (e.g., the first Wi-Fi session, performed between a first APs 805 (e.g., AP-1) and RF devices 810). Specifically, the first Wi-Fi ranging session may be scheduled at the same time with the UWB ranging session but performed on different RF channels (e.g., the Wi-Fi ranging session and the UWB ranging session are performed on different RF channels at each time point during the Wi-Fi ranging session and the UWB ranging session). This could reduce the transmission overhead for each of the ranging sessions and thus increase the efficiency/reduce the latency of the hybrid positioning session. Accordingly, the position of the one or more participating RF devices 710 may be determined as a result of the hybrid positioning session (e.g., utilizing UWB-based and Wi-Fi-based positioning).

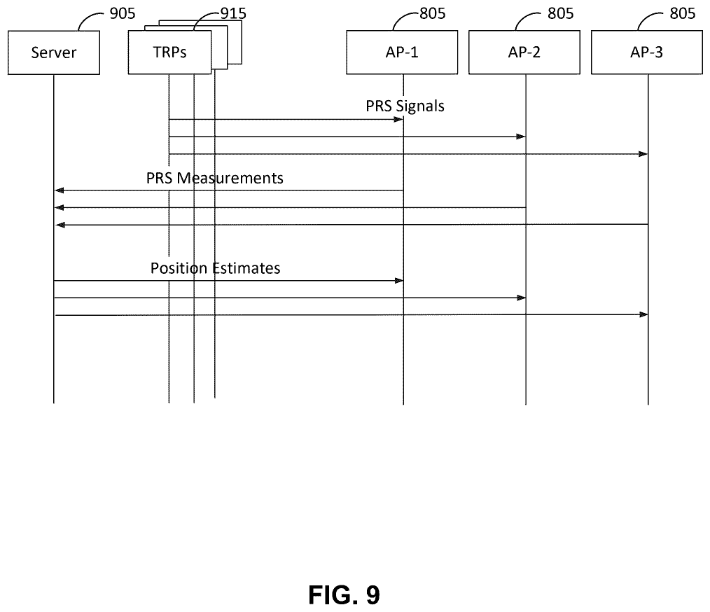

As noted above, for Wi-Fi positioning sessions (e.g., in downlink-TDoA positionings), a server and/or one or more TRPs may be used to position APs 805. In some embodiments, positioning of the one or more APs 805 may be performed ahead of time (e.g., at a time point prior to performing the hybrid positioning session) or as part of the hybrid positioning session. For example, FIG. 9 illustrates how one or more APs 805 may be positioned, according to some embodiments. In some embodiments, server 905 may correspond to coordinating RF device 705 shown in FIG. 7 or may be a server (e.g., a location server (e.g., location server 160 shown in FIG. 1) or a private server) different from coordinating RF device 705. TRPs 915 may be associated with a base station (e.g., base station 120 shown in FIG. 1). For example, as illustrated in FIG. 9, TRPs 915 may transmit one or more PRS signals to each of APs 805. Each AP 805 may determine one or more PRS measurements (e.g., ToA, TDoA, and/or AoA derived from/determined based on the PRS signals) based on the received PRS signals and may transmit the PRS measurements to server 905. Accordingly, server 905 may determine/estimate the location of each AP 805 based on the corresponding PRS measurements.

In some embodiments, to further increase the ranging/positioning accuracy and leverage more RF ranging technologies available to coordinating RF device 705 and/or participating RF devices 710, coordinating RF device 705 and/or participating RF devices 710 may also perform the NR-based positioning (e.g., with one or more of the TRPs shown in FIG. 9 and/or associated with base station 120 shown in FIG. 1, similar to the process discussed with regard to FIG. 2A) as being part of the hybrid positioning session. In some embodiments, the NR-based positioning may be scheduled alternatively (e.g., in a TDM and/or a FDM fashion with) or in addition to (e.g., during APs 805 positioning stage) the UWB ranging session and the Wi-Fi ranging session.

Referring back to FIG. 7, in some embodiments, the process may further include arrows 745 and 750, where one or more participating RF devices may transmit a position estimation request to coordinating RF device 705 requesting the position estimation (e.g., determined according to the hybrid positioning session), and in response to the request, coordinating RF device 705 may transmit the position estimation to the one or more participating RF devices 710 making the request.

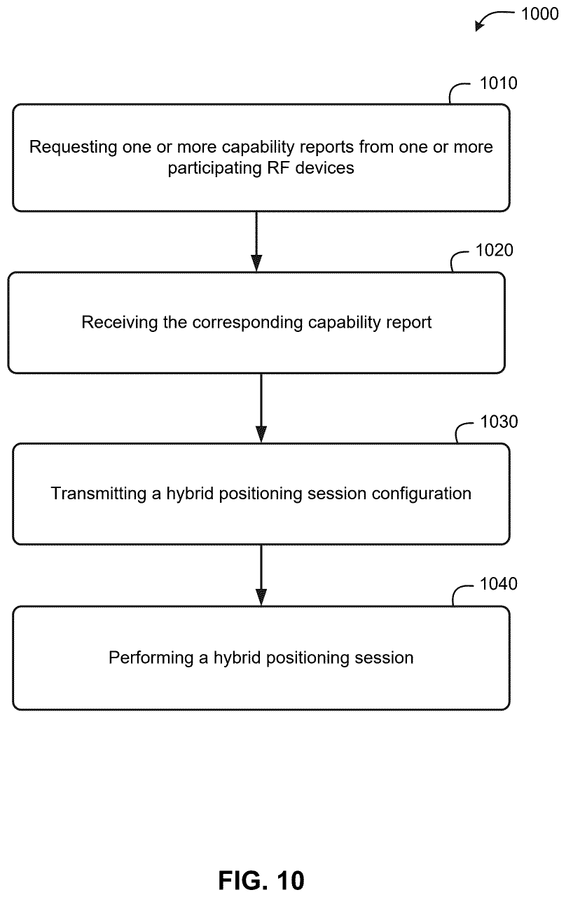

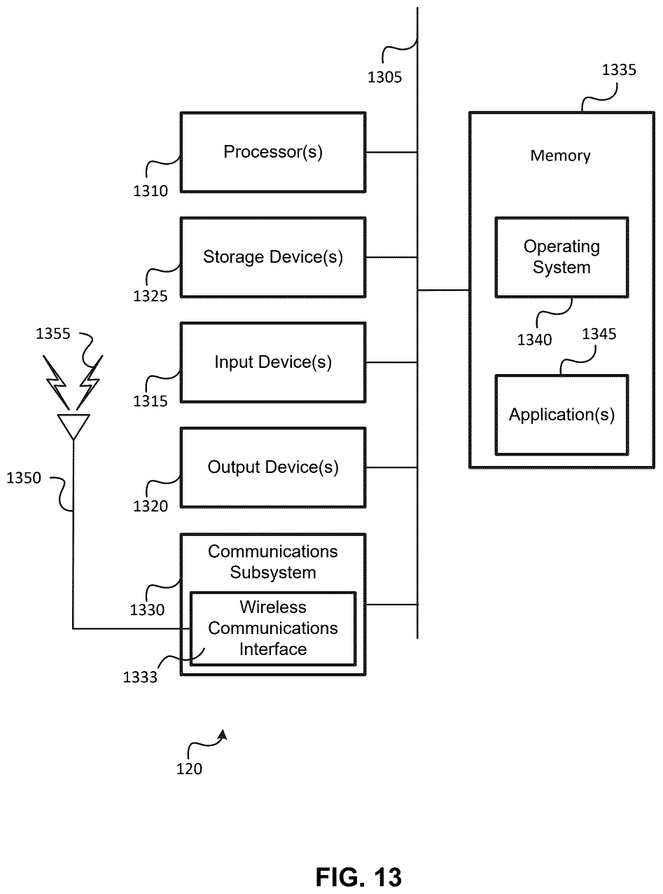

FIG. 10 is a flow diagram of a method 1000 of hybrid positioning performed by a coordinating RF device, according to an embodiment. In some embodiments, the coordinating RF device may correspond to coordinating RF device 705 shown in FIG. 7. Means for performing the functionality illustrated in one or more of the blocks shown in FIG. 10 may be performed by hardware and/or software components of a UE and/or server. Example components of a UE and/or server are illustrated in FIGS. 32 and 13 respectively, which is described in more detail below. As noted above, the coordinating RF device may be a controller of a UWB ranging session or a server.

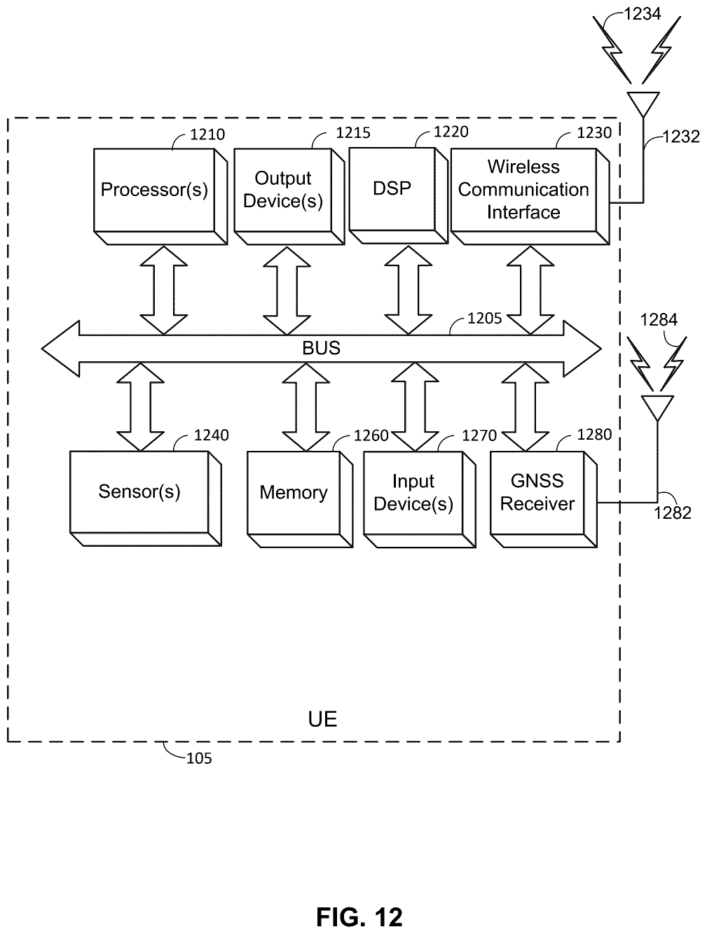

At block 1010, the functionality comprises requesting one or more capability reports from one or more participating RF devices (e.g., participating RF device 710 shown in FIG. 7). Means for performing functionality at block 1010 may comprise a bus 1205, processor(s) 1210, memory 1260, wireless communication interface 1230, and/or other components of UE 105, as illustrated in FIG. 12. Means for performing functionality at block 1010 may also comprise a bus 1305, processor(s) 1310, memory 1335, wireless communication interface 1333, and/or other components of UE 1300, as illustrated in FIG. 13.

As noted above, in some embodiments, each capability report may at least include parameters indicating whether the participating RF device: 1. Participates in a present hybrid positioning session utilizing each of a plurality of RF positioning technologies (e.g., Wi-Fi, UWB, NR); 2. supports each of the plurality of RF positioning technologies; 3. supports one or more RF channels for RF positioning, or any combination thereof. In some embodiments, the capability report may also include parameters such as the desired position accuracy, configurations for the duty cycle, etc. In some embodiments, the corresponding information for each participating RF device may be represented/indicated by one or more predetermined bits of the exchanged messages. For example, at a predetermined slot, “0” may represent not participating the present hybrid positioning session and “1” may represent participating the present hybrid positioning session.

At block 1020, the functionality comprises receiving from each participating RF device, the corresponding capability report. Means for performing functionality at block 1020 may comprise a bus 1205, processor(s) 1210, memory 1260, wireless communication interface 1230, and/or other components of UE 105, as illustrated in FIG. 12. Means for performing functionality at block 1020 may also comprise a bus 1305, processor(s) 1310, memory 1335, wireless communication interface 1333, and/or other components of UE 1300, as illustrated in FIG. 13.

In some embodiments, after receiving from each participating RF device, the corresponding capability report, the coordinating RF device may determine a hybrid positioning session configuration for the present hybrid positioning session based on the one or more capability reports. In some embodiments, the hybrid positioning session configuration may include information of 1. the time and frequency stamps, and an intended recipient for a transmission of one or more ranging messages of a given RF technology; 2. time and frequency stamps, and an intended transmitter for a reception of the one or more ranging messages of the given RF technology; and 3. periodicity parameters of the one or more ranging messages. In some embodiments, the periodicity parameters may include the number of the repetitions of the one or more ranging messages, duration of the hybrid positioning session (e.g., when a next capability report request may be exchanged), configuration for the duty cycle (e.g., define an “off” period where no reference signals are transmitted).

For example, in some embodiments, the plurality of RF positioning technologies may include UWB and a contention-based RF technology where the one or more participating RF devices are further positioned according to one or more APs. In some embodiments, the hybrid positioning session configuration may further include a time-division multiplexing (TDM) or a frequency-division multiplexing (FDM) for scheduling the contention-based RF technology.

In some embodiments, according to the hybrid positioning session configuration described with regard to FIG. 8A, the one or more APs may include a first AP and a second AP, wherein the contention-based RF technology may include Wi-Fi. The hybrid positioning session configuration may be configured to: schedule a first Wi-Fi ranging session between the first AP and the one or more participating RF devices at a first time point; schedule a second Wi-Fi ranging session between the second AP and the one or more participating RF devices at a second time point; and schedule a UWB ranging session between the coordinating RF device and the one or more participating RF devices, such that the UWB ranging session may be scheduled between the first time point and the second time point.

In some embodiments, according to the hybrid positioning session configuration described with regard to FIG. 8B, the contention-based RF technology may include Wi-Fi, and the hybrid positioning session configuration may be configured to: schedule a simultaneous performance of a Wi-Fi ranging session between an AP of the one or more APs and the one or more participating RF devices, and a UWB ranging session between the coordinating RF device and the one or more participating RF devices, such that at each time point, the Wi-Fi ranging session and the UWB ranging session are performed on different RF channels.

In some embodiments, the plurality of RF positioning technologies may further include NR.

At block 1030, the functionality comprises transmitting, to the participating RF devices that participate in the present hybrid positioning session, the hybrid positioning session configuration. Means for performing functionality at block 1030 may comprise a bus 1205, processor(s) 1210, memory 1260, wireless communication interface 1230, and/or other components of UE 105, as illustrated in FIG. 12. Means for performing functionality at block 1030 may also comprise a bus 1305, processor(s) 1310, memory 1335, wireless communication interface 1333, and/or other components of UE 1300, as illustrated in FIG. 13.

In some embodiments, the hybrid positioning session configuration may be transmitted using a UWB control message of the UWB ranging session. For example, the capability report may be included in the assistance data transmitted from coordinating RF device 705 to one or more participating RF device 710. Additionally or alternatively, the hybrid positioning session configuration may be transmitted using a RF technology different from the plurality of RF positioning technologies. For example, the hybrid positioning session configuration may be transmitted OOB e.g., via other RF technologies such as internet, Bluetooth network, etc.

At block 1040, the functionality comprises performing the hybrid positioning session according to the hybrid positioning session configuration. Means for performing functionality at block 1040 may comprise a bus 1205, processor(s) 1210, memory 1260, wireless communication interface 1230, and/or other components of UE 105, as illustrated in FIG. 12. Means for performing functionality at block 1040 may also comprise a bus 1305, processor(s) 1310, memory 1335, wireless communication interface 1333, and/or other components of UE 1300, as illustrated in FIG. 13.

As noted above, in some embodiments, method 1000 may also optionally include determining the position of the one or more APs. For example, a server (e.g., the coordinating RF device and/or a separate server) may receive, from the one or more APs, one or more positioning reference signals (PRSs) measurements determined by the one or more APs and determine positions of the one or more APs based on the one or more PRSs measurements.

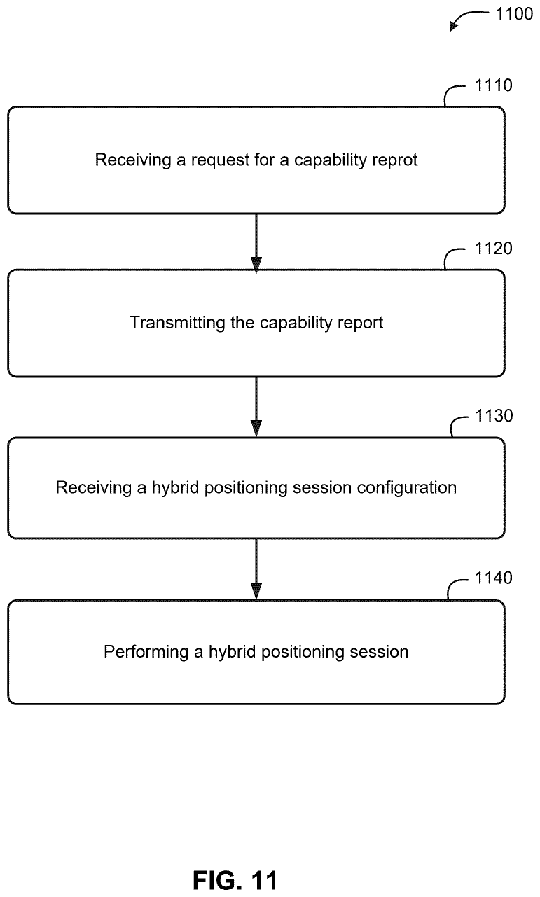

FIG. 11 is a flow diagram of a method 1100 of hybrid positioning performed by a participating RF device, according to an embodiment. Means for performing the functionality illustrated in one or more of the blocks shown in FIG. 11 may be performed by hardware and/or software components of a UE. Example components of a UE are illustrated in FIGS. 32, which is described in more detail below.

At block 1110, the functionality comprises receiving, from a coordinating RF device, a request for a capability report. Means for performing functionality at block 1110 may comprise a bus 1205, processor(s) 1210, memory 1260, wireless communication interface 1230, and/or other components of UE 105, as illustrated in FIG. 12.

As noted above, the capability report may at least include parameters indicating whether the participating RF device: 1. participates in a present hybrid positioning session utilizing each of a plurality of RF positioning technologies (e.g., Wi-Fi, UWB, NR); 2. supports each of the plurality of RF positioning technologies; 3. supports one or more RF channels for RF positioning, or any combination thereof. In some embodiments, the capability report may also include parameters such as the desired position accuracy, configurations for the duty cycle, etc. In some embodiments, the corresponding information for each participating RF device 710 may be represented/indicated by one or more predetermined bits of the exchanged messages. For example, at a predetermined slot, “0” may represent not participating the present hybrid positioning session and “1” may represent participating the present hybrid positioning session.

At block 1120, the functionality comprises transmitting, to coordinating RF device, the capability report. Means for performing functionality at block 1020 may comprise a bus 1205, processor(s) 1210, memory 1260, wireless communication interface 1230, and/or other components of UE 105, as illustrated in FIG. 12.

At block 1130, the functionality comprises receiving, from the coordinating RF device, a hybrid positioning session configuration. Means for performing functionality at block 1130 may comprise a bus 1205, processor(s) 1210, memory 1260, wireless communication interface 1230, and/or other components of UE 105, as illustrated in FIG. 12. As noted above, in some embodiments, the hybrid positioning session configuration may include information of 1. the time and frequency stamps, and an intended recipient for a transmission of one or more ranging messages of a given RF technology; 2. time and frequency stamps, and an intended transmitter for a reception of the one or more ranging messages of the given RF technology; and 3. periodicity parameters of the one or more ranging messages. In some embodiments, the periodicity parameters may include the number of the repetitions of the one or more ranging messages, duration of the hybrid positioning session (e.g., when a next capability report request may be exchanged), configuration for the duty cycle (e.g., define an “off” period where no reference signals are transmitted). Example hybrid positioning session configurations will be discuss in detail below with regard to the description of FIGS. 8A and 8B below.

For example, in some embodiments, the plurality of RF positioning technologies may include UWB and a contention-based RF technology where the one or more participating RF devices are further positioned according to one or more APs. In some embodiments, the hybrid positioning session configuration may further include a time-division multiplexing (TDM) or a frequency-division multiplexing (FDM) for scheduling the contention-based RF technology.

In some embodiments, according to the hybrid positioning session configuration described with regard to FIG. 8A, the one or more APs may include a first AP and a second AP, wherein the contention-based RF technology may include Wi-Fi. The hybrid positioning session configuration may be configured to: schedule a first Wi-Fi ranging session between the first AP and the one or more participating RF devices at a first time point; schedule a second Wi-Fi ranging session between the second AP and the one or more participating RF devices at a second time point; and schedule a UWB ranging session between the coordinating RF device and the one or more participating RF devices, such that the UWB ranging session is scheduled between the first time point and the second time point.

In some embodiments, according to the hybrid positioning session configuration described with regard to FIG. 8B, the contention-based RF technology may include Wi-Fi, and the hybrid positioning session configuration may be configured to: schedule a simultaneous performance of a Wi-Fi ranging session between an AP of the one or more APs and the one or more participating RF devices, and a UWB ranging session between the coordinating RF device and the one or more participating RF devices, such that at each time point, the Wi-Fi ranging session and the UWB ranging session are performed on different RF channels.

In some embodiments, the plurality of RF positioning technologies may further include NR.

In some embodiments, the hybrid positioning session configuration may be received using a UWB control message of the UWB ranging session. For example, the capability report may be included in the assistance data transmitted from coordinating RF device 705 to one or more participating RF device 710. Additionally or alternatively, the hybrid positioning session configuration may be transmitted using a RF technology different from the plurality of RF positioning technologies. For example, the hybrid positioning session configuration may be transmitted OOB e.g., via other RF technologies such as internet, Bluetooth network, etc.

At block 1140, the functionality comprises performing the hybrid positioning session according to the hybrid positioning session configuration. Means for performing functionality at block 1140 may comprise a bus 1205, processor(s) 1210, memory 1260, wireless communication interface 1230, and/or other components of UE 105, as illustrated in FIG. 12.

FIG. 3 is a block diagram of an embodiment of a UE 105, which can be utilized as described herein above (e.g., in association with FIGS. 1-10). For example, the UE 105 can perform one or more of the functions of the method shown in FIG. 9 or 10. It should be noted that FIG. 3 is meant only to provide a generalized illustration of various components, any or all of which may be utilized as appropriate. It can be noted that, in some instances, components illustrated by FIG. 3 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 3.

The UE 105 is shown comprising hardware elements that can be electrically coupled via a bus 305 (or may otherwise be in communication, as appropriate). The hardware elements may include a processor(s) 310 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 310 may comprise one or more processing units, which may be housed in a single integrated circuit (IC) or multiple ICs. As shown in FIG. 3, some embodiments may have a separate DSP 320, depending on desired functionality. Location determination and/or other determinations based on wireless communication may be provided in the processor(s) 310 and/or wireless communication interface 330 (discussed below). The UE 105 also can include one or more input devices 370, which can include without limitation one or more keyboards, touch screens, touch pads, microphones, buttons, dials, switches, and/or the like; and one or more output devices 315, which can include without limitation one or more displays (e.g., touch screens), light emitting diodes (LEDs), speakers, and/or the like.

The UE 105 may also include a wireless communication interface 330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 330 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 332 that send and/or receive wireless signals 334. According to some embodiments, the wireless communication antenna(s) 332 may comprise a plurality of discrete antennas, antenna arrays, or any combination thereof. The antenna(s) 332 may be capable of transmitting and receiving wireless signals using beams (e.g., Tx beams and Rx beams). Beam formation may be performed using digital and/or analog beam formation techniques, with respective digital and/or analog circuitry. The wireless communication interface 330 may include such circuitry.

Depending on desired functionality, the wireless communication interface 330 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 340. Sensor(s) 340 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 380 capable of receiving signals 384 from one or more GNSS satellites using an antenna 382 (which could be the same as antenna 332). Positioning based on GNSS signal measurement can be utilized to complement and/or incorporate the techniques described herein. The GNSS receiver 380 can extract a position of the UE 105, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 380 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 380 is illustrated in FIG. 3 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 310, DSP 320, and/or a processor within the wireless communication interface 330 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 310 or DSP 320.

The UE 105 may further include and/or be in communication with a memory 360. The memory 360 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 360 of the UE 105 also can comprise software elements (not shown in FIG. 3), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 360 that are executable by the UE 105 (and/or processor(s) 310 or DSP 320 within UE 105). In some embodiments, then, such code and/or instructions can be used to configure and/or adapt a general-purpose computer (or other device) to perform one or more operations in accordance with the described methods.

FIG. 4 is a block diagram of an embodiment of a base station 120, which can be utilized as described herein above (e.g., in association with FIGS. 1-9). It should be noted that FIG. 4 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 405 (or may otherwise be in communication, as appropriate). The hardware elements may include a processor(s) 410 which can include without limitation one or more general-purpose processors, one or more special-purpose processors (such as DSP chips, graphics acceleration processors, ASICs, and/or the like), and/or other processing structure or means. As shown in FIG. 4, some embodiments may have a separate DSP 420, depending on desired functionality. Location determination and/or other determinations based on wireless communication may be provided in the processor(s) 410 and/or wireless communication interface 430 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 430, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 430 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 432 that send and/or receive wireless signals 434.

The base station 120 may also include a network interface 480, which can include support of wireline communication technologies. The network interface 480 may include a modem, network card, chipset, and/or the like. The network interface 480 may include one or more input and/or output communication interfaces to permit data to be exchanged with a network, communication network servers, computer systems, and/or any other electronic devices described herein.

In many embodiments, the base station 120 may further comprise a memory 460. The memory 460 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 460 of the base station 120 also may comprise software elements (not shown in FIG. 4), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 460 that are executable by the base station 120 (and/or processor(s) 410 or DSP 420 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of hybrid positioning performed by a coordinating radio frequency (RF) device. The method may comprise requesting one or more capability reports from one or more participating RF devices, wherein a capability report comprises parameters indicating whether the participating RF device: participates in a present hybrid positioning session utilizing each of a plurality of RF positioning technologies; and supports one or more RF channels for RF positioning; receiving, from each participating RF device, the corresponding capability report. The method may also comprise transmitting, to the participating RF devices that participate in the present hybrid positioning session, a hybrid positioning session configuration, determined based on the capability reports.
Clause 2. The method of clause 1, wherein the hybrid positioning session configuration comprises: time and frequency stamps, and an intended recipient for a transmission of one or more ranging messages of the present hybrid positioning session; time and frequency stamps, and an intended transmitter for a reception of the one or more ranging messages; and periodicity parameters of the one or more ranging messages.
Clause 3. The method of clause 1 or 2, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.
Clause 4. The method of any of clauses 1-3, wherein the coordinating RF device comprises a controller of a UWB ranging session.
Clause 5. The method of any of clauses 1-4, wherein the coordinating RF device comprises a server.
Clause 6. The method of any of clauses 1-5, further comprising: receiving, from the one or more APs, one or more positioning reference signals (PRSs) measurements determined by the one or more APs; and determining positions of the one or more APs based on the one or more PRSs measurements.
Clause 7. The method of any of clauses 1-6, wherein the one or more APs comprises a first AP and a second AP, wherein the contention-based RF technology comprises Wi-Fi, and wherein the hybrid positioning session configuration is configured to: schedule a first Wi-Fi ranging session between the first AP and the one or more participating RF devices at a first time point; schedule a second Wi-Fi ranging session between the second AP and the one or more participating RF devices at a second time point; and schedule a UWB ranging session between the coordinating RF device and the one or more participating RF devices, wherein the UWB ranging session is scheduled between the first time point and the second time point.
Clause 8. The method of any of clauses 1-7, wherein the contention-based RF technology comprises Wi-Fi, and wherein the hybrid positioning session configuration is configured to: schedule a simultaneous performance of a Wi-Fi ranging session between an AP of the one or more APs and the one or more participating RF devices, and a UWB ranging session between the coordinating RF device and the one or more participating RF devices, wherein at each time point, the Wi-Fi ranging session and the UWB ranging session are performed on different RF channels.
Clause 9. The method of any of clauses 1-8, wherein the plurality of RF positioning technologies further comprise New Radio (NR).
Clause 10. The method of any of clauses 1-9, further comprising: transmitting the hybrid positioning session configuration using a UWB control message of the UWB ranging session.
Clause 11. The method of any of clauses 1-10, further comprising: transmitting the hybrid positioning session configuration using a RF technology different from the plurality of RF positioning technologies.
Clause 12. A method of hybrid positioning performed by a participating radio frequency (RF) device. The method may comprise receiving, from a coordinating RF device, a request for a capability report, indicating whether the participating RF device participates in a present hybrid positioning session utilizing each of a plurality of RF positioning technologies; and supports one or more RF channels for RF positioning; receiving, from each participating RF device, the corresponding capability report. The method may also comprise transmitting, to the coordinating RF device, the capability report. In response to participating the present hybrid positioning session, the method may also comprise receiving, from the coordinating RF device, a hybrid positioning session configuration, determined based on the capability report.
Clause 13. The method of clause 12, wherein the hybrid positioning session configuration comprises: time and frequency stamps, and an intended recipient for a transmission of one or more ranging messages of the present hybrid positioning session; time and frequency stamps, and an intended transmitter for a reception of the one or more ranging messages; and periodicity parameters of the one or more ranging messages.
Clause 14. The method of clause 12 or 13, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.
Clause 15. The method of any of clauses 12-14, wherein the coordinating RF device comprises a controller of a UWB ranging session, and wherein the method further comprises: transmitting the hybrid positioning session configuration to a different participating RF device that participates in the present hybrid positioning session.
Clause 16. The method of any of clauses 12-15, wherein the coordinating RF device comprises a server.
Clause 17. The method of any of clauses 12-16, wherein positions of the one or more APs is determined by the server based on one or more positioning reference signals (PRSs) measurements determined by the one or more APs.
Clause 18. The method of any of clauses 12-17, wherein the one or more APs comprises a first AP and a second AP, wherein the contention-based RF technology comprises Wi-Fi, and wherein the hybrid positioning session configuration is configured to: schedule a first Wi-Fi ranging session between the first AP and the one or more participating RF devices at a first time point; schedule a second Wi-Fi ranging session between the second AP and the one or more participating RF devices at a second time point; and schedule a UWB ranging session between the coordinating RF device and the one or more participating RF devices, wherein the UWB ranging session is scheduled between the first time point and the second time point.
Clause 19. The method of any of clauses 12-18, wherein the contention-based RF technology comprises Wi-Fi, and wherein the hybrid positioning session configuration is configured to: schedule a simultaneous performance of a Wi-Fi ranging session between an AP of the one or more APs and the one or more participating RF devices, and a UWB ranging session between the coordinating RF device and the one or more participating RF devices, wherein at each time point, the Wi-Fi ranging session and the UWB ranging session are performed on different RF channels.
Clause 20. The method of any of clauses 12-19, wherein the plurality of RF positioning technologies further comprise New Radio (NR).
Clause 21. The method of any of clauses 12-20, further comprising: receiving the hybrid positioning session configuration using a UWB control message of the UWB ranging session.
Clause 22. The method of any of clauses 12-21, further comprising: receiving the hybrid positioning session configuration using a RF technology different from the plurality of RF positioning technologies.
Clause 23. A coordinating radio frequency (RF) device for hybrid positioning, the coordination RF device comprising a transceiver, a memory, one or more processors communicatively coupled with the transceiver and the memory, wherein the one or more processors may be configured to request one or more capability reports from one or more participating RF devices, wherein a capability report comprises parameters indicating whether the participating RF device: participates in a present hybrid positioning session utilize each of a plurality of RF positioning technologies; and supports one or more RF channels for RF positioning. The one or more processors may also be configured to receive, from each participating RF device, the corresponding capability report. The one or more processors may also be configured to transmit, to the participating RF devices that participate in the present hybrid positioning session, a hybrid positioning session configuration, determined based on the capability reports.
Clause 24. The coordinating RF device of clause 23, wherein the hybrid positioning session configuration comprises: time and frequency stamps, and an intended recipient for a transmission of one or more ranging messages of the present hybrid positioning session; time and frequency stamps, and an intended transmitter for a reception of the one or more ranging messages; and periodicity parameters of the one or more ranging messages.
Clause 25. The coordinating RF device of clause 23 or 24, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.
Clause 26. The coordinating RF device of any of clauses 23-25, wherein the coordinating RF device comprises a controller of a UWB ranging session or a server.
Clause 27. A participating radio frequency (RF) device for hybrid positioning, the coordination RF device comprising a transceiver, a memory, one or more processors communicatively coupled with the transceiver and the memory, wherein the one or more processors may be configured to receive, from a coordinating RF device, a request for a capability report, indicating whether the participating RF device: participates in a present hybrid positioning session utilize each of a plurality of RF positioning technologies; and supports one or more RF channels for RF positioning. In response to participating the present hybrid positioning session, the one or more processors may also be configured to receive, from the coordinating RF device, a hybrid positioning session configuration, determined based on the capability report.
Clause 28. The coordinating RF device of clause 27, wherein the hybrid positioning session configuration comprises: time and frequency stamps, and an intended recipient for a transmission of one or more ranging messages of the present hybrid positioning session; time and frequency stamps, and an intended transmitter for a reception of the one or more ranging messages; and periodicity parameters of the one or more ranging messages.
Clause 29. The coordinating RF device of clause 27 or 28, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.
Clause 30. The coordinating RF device of any of clauses 27-29, wherein the coordinating RF device comprises a server.

1. A method of hybrid positioning performed by a coordinating radio frequency (RF) device, the method comprising:
requesting one or more capability reports from one or more participating RF devices, wherein a capability report comprises parameters indicating whether the participating RF device: participates in a present hybrid positioning session utilizing each of a plurality of RF positioning technologies; and
supports one or more RF channels for RF positioning; receiving, from each participating RF device, the corresponding capability report; and
transmitting, to the participating RF devices that participate in the present hybrid positioning session, a hybrid positioning session configuration, determined based on the capability reports.

2. The method of claim 1, wherein the hybrid positioning session configuration comprises:
time and frequency stamps, and an intended recipient for a transmission of one or more ranging messages of the present hybrid positioning session;
time and frequency stamps, and an intended transmitter for a reception of the one or more ranging messages; and
periodicity parameters of the one or more ranging messages.

3. The method of claim 2, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.

4. The method of claim 3, further comprising transmitting the hybrid positioning session configuration using a UWB control message of a UWB ranging session, and wherein the coordinating RF device comprises a controller of the UWB ranging session.

5. (canceled)

6. The method of claim 3, further comprising:
receiving, from the one or more APs, one or more positioning reference signals (PRSs) measurements determined by the one or more APs; and determining positions of the one or more APs based on the one or more PRSs measurements.

7. The method of claim 3, wherein the one or more APs comprises a first AP and a second AP, wherein the contention-based RF technology comprises WiFi, and wherein the hybrid positioning session configuration is configured to:
schedule a first Wi-Fi ranging session between the first AP and the one or more participating RF devices at a first time point;
schedule a second Wi-Fi ranging session between the second AP and the one or more participating RF devices at a second time point; and
schedule a UWB ranging session between the coordinating RF device and the one or more participating RF devices, wherein the UWB ranging session is scheduled between the first time point and the second time point.

8. The method of claim 3, wherein the contention-based RF technology comprises Wi-Fi, and wherein the hybrid positioning session configuration is configured to:
schedule a simultaneous performance of a Wi-Fi ranging session between an AP of the one or more APs and the one or more participating RF devices, and a UWB ranging session between the coordinating RF device and the one or more participating RF devices, wherein at each time point, the Wi-Fi ranging session and the UWB ranging session are performed on different RF channels.

9. (canceled)

10. (canceled)

11. The method of claim 1, further comprising:
transmitting the hybrid positioning session configuration using a RF technology different from the plurality of RF positioning technologies.

12. A method of hybrid positioning performed by a participating radio frequency (RF) device, the method comprising:
receiving, from a coordinating RF device, a request for a capability report, indicating whether the participating RF device:
participates in a present hybrid positioning session utilizing each of a plurality of RF positioning technologies; and
supports one or more RF channels for RF positioning; transmitting, to the coordinating RF device, the capability report; and in response to participating the present hybrid positioning session, receiving, from the coordinating RF device, a hybrid positioning session configuration, determined based on the capability report.

13. The method of claim 12, wherein the hybrid positioning session configuration comprises:
time and frequency stamps, and an intended recipient for a transmission of one or more ranging messages of the present hybrid positioning session;
time and frequency stamps, and an intended transmitter for a reception of the one or more ranging messages; and
periodicity parameters of the one or more ranging messages.

14. The method of claim 13, wherein the plurality of RF positioning technologies comprise UWB and a contention-based RF technology, wherein the participating RF device is further positioned according to one or more access points (APs), and wherein the hybrid positioning session configuration further comprises a time-division multiplexing (TDM) or a frequency-division multiplexing (FDM) for scheduling the UWB and the contention-based RF technology.

15. The method of claim 14, wherein the coordinating RF device comprises a controller of a UWB ranging session, and wherein the method further comprises:
transmitting the hybrid positioning session configuration to a different participating RF device that participates in the present hybrid positioning session,
receiving the hybrid positioning session configuration using a UWB control message of the UWB ranging session.

16. (canceled)

17. The method of claim 14, wherein positions of the one or more APs is determined by a server, comprised in the coordinating RF device, based on one or more positioning reference signals (PRSs) measurements determined by the one or more APs.

18. The method of claim 14, wherein the one or more APs comprises a first AP and a second AP, wherein the contention-based RF technology comprises WiFi, and wherein the hybrid positioning session configuration is configured to:
schedule a first Wi-Fi ranging session between the first AP and the participating RF device at a first time point;
schedule a second Wi-Fi ranging session between the second AP and the participating RF device at a second time point; and
schedule a UWB ranging session between the coordinating RF device and the participating RF device, wherein the UWB ranging session is scheduled between the first time point and the second time point.

19. The method of claim 14, wherein the contention-based RF technology comprises Wi-Fi, and wherein the hybrid positioning session configuration is configured to: schedule a simultaneous performance of a Wi-Fi ranging session between an AP of the one or more APs and the participating RF device, and a UWB ranging session between the coordinating RF device and the participating RF device, wherein at each time point, the Wi-Fi ranging session and the UWB ranging session are performed on different RF channels for RF positioning.

20. (canceled)

21. (canceled)

22. The method of claim 13, further comprising:
receiving the hybrid positioning session configuration using a RF technology different from the plurality of RF positioning technologies.

23. A coordinating radio frequency (RF) device for hybrid positioning, the coordination RF device comprising:
one or more transceivers capable of transmitting UWB wireless signals; a memory; and
one or more processors communicatively coupled with the one or more transceivers and the memory, wherein the one or more processors are configured to:
request one or more capability reports from one or more participating RF devices, wherein a capability report comprises parameters indicating whether the participating RF device:
participates in a present hybrid positioning session utilize each of a plurality of RF positioning technologies; and supports one or more RF channels for RF positioning; receive, from each participating RF device, the corresponding capability report; and
transmit, to the participating RF devices that participate in the present hybrid positioning session, a hybrid positioning session configuration, determined based on the capability reports.

24. The coordinating RF device of claim 23, wherein the hybrid positioning session configuration comprises:
time and frequency stamps, and an intended recipient for a transmission of one or more ranging messages of the present hybrid positioning session;
time and frequency stamps, and an intended transmitter for a reception of the one or more ranging messages; and
periodicity parameters of the one or more ranging messages.

25. The coordinating RF device of claim 24, wherein the plurality of RF positioning technologies comprise UWB and a contention-based RF technology, wherein the one or more participating RF devices are further positioned according to one or more access points (APs), and wherein the hybrid positioning session configuration further comprises a time-division multiplexing (TDM) or a frequency-division multiplexing (FDM) for scheduling the UWB and the contention-based RF technology.

26. The coordinating RF device of claim 25, wherein the coordinating RF device comprises a controller of a UWB ranging session or a server.

27. (canceled)

28. (canceled)

29. (canceled)

30. (canceled)
